(19) United States
(12) Patent Application Publication
(10) Pub. No.: US 2012/0032786 A1
(43) Pub. Date: Feb. 9, 2012

(54) COMMUNICATION DEVICE

(75) Inventor: Toshio TAKAHASHI, Niigata-ken (JP)

(73) Assignee: ALPS ELECTRIC CO., LTD., Tokyo (JP)

(21) Appl. No.: 13/273,059

(22) Filed: Oct. 13, 2011

Related U.S. Application Data
(63) Continuation of application No. PCT/JP2010/058873, filed on May 26, 2010.

(30) Foreign Application Priority Data
May 26, 2009 (JP) 2009-126169

(51) Int. Cl. G06K 7/01

(52) U.S. Cl. 340/10.1

(57) ABSTRACT

A communication device includes a tag and a magnetic member. The tag communicates with an external device by radio, and the magnetic member is provided on the side opposite to the external device so as to face the tag. The magnetic member is formed to have a laminated structure that includes a high-μ′ layer and a low-μ′ layer. The high-μ′ layer is provided on the tag. The low-μ′ layer is provided so as to be more distant from the tag than the high-μ′ layer. A real part μ′ of complex relative permeability of the low-μ′ layer is lower than a real part μ′ of the complex relative permeability of the high-μ′ layer, and the thickness of the low-μ′ layer is larger than the thickness of the high-μ′ layer.

### CLAIM OF PRIORITY

This application is a Continuation of International Application No. PCT/JP2010/058873 filed on May 26, 2010, which claims benefit of Japanese Patent Application No. 2009-126169 filed on May 26, 2009. The entire contents of the application noted above are hereby incorporated by reference.

### BACKGROUND OF THE INVENTION

1. Field of the Invention

The present invention relates to a communication device that includes a tag and a magnetic member.

2. Description of the Related Art

FIG. 3 is a schematic view showing the structure of an RFID communication device in the related art. As shown in FIG. 3, a communication device 1 has a structure where a tag 2, a magnetic sheet 3, a base material 4 supporting the magnetic sheet 3, and a resin sheet 5 are laminated. Meanwhile, although not shown, double-sided tapes or adhesive layers are present between the respective members and bond the respective members.

Further, as shown in FIG. 3, the resin sheet 5 is adhered through an adhesive layer (not shown) to the surface of, for example, a mobile phone 6.

In the structure shown in FIG. 3 where the communication device 1 includes the magnetic sheet 3, there has been a problem in that eddy current is generated in a metal member of the mobile phone 6 due to a magnetic field generated from a reader/writer and a demagnetizing field generated due to the eddy current cancels out a magnetic field required for radio communication. For this reason, if the magnetic sheet 3 is provided on the back side of the tag 2 (the side corresponding to the mobile phone 6) as shown in FIG. 3, the magnetic sheet 3 can attract the magnetic flux, which is generated from a reader/writer, toward the tag 2, magnetic flux can pass through a gap between an antenna of the reader/writer and an antenna of the tag 2, and the amount of the attenuated output of a signal received by the antenna of the tag 2 can be reduced. As a result, it may be possible to improve the characteristics of RFID.

### SUMMARY OF THE INVENTION

While the type of the magnetic sheet 3 was changed, a resonant frequency and the maximum communication distance were obtained using the communication device 1 in the related art having the structure shown in FIG. 3. Meanwhile, experiments were performed first while the communication device 1 was not adhered to the mobile phone 6 (single communication device 1).

In the experiments, communication devices according to Conventional Examples 1 to 4 using magnetic sheets A to D shown in the following Table 3 were prepared.

TABLE 3

| | | Maximum | Resonant | | | | |
|---|---|---|---|---|---|---|---|
| | Magnetic | communication | frequency | | | | |
| | sheet | distance [mm] | [MHz] | μ′ | μ″ | t [μm] | μ′ × t |
| Conventional | A 80R-0.05 t | 26 | 16.15 | 82.7 | 24.56 | 49 | 4.07 |
| Example 1 | | | | | | | |
| Conventional | B 60R-0.05 t | 25 | 16.36 | 67.7 | 17.95 | 49 | 3.32 |
| Example 2 | | | | | | | |
| Conventional | C 40R-0.05 t | 33 | 16.72 | 45.3 | 6.20 | 43 | 1.95 |
| Example 3 | | | | | | | |
| Conventional | D 3M- | 34 | 16.54 | 19.9 | 1.00 | 101 | 2.01 |
| Example 4 | 5010B | | | | | | |

The magnetic sheets A to C are products manufactured by Alps Electric Co., Ltd. and the magnetic sheet D is a product manufactured by 3M.

As shown in Table 3, the real parts μ′ of the complex relative permeability of the respective magnetic sheets A to D have values that are substantially different in the range of 20 to 80. The thicknesses t of the respective magnetic sheets A to D are shown in Table 1. Further, the sum of the thickness of the base material 4 and the thickness of an adhesive layer was about 70 μm. Furthermore, the sum of the thickness of the resin sheet 5 and the thickness of an adhesive layer was about 170 μm. Moreover, the thickness of the double-sided tape interposed between the tag 2 and the magnetic sheet 3 was about 10 μm.

DENSO WAVE PR-301RKM was used as a reader/writer. Further, the experimental results of a resonant frequency and the maximum communication distance of each of the communication devices 1 (which are used alone without being adhered to a mobile phone) according to Conventional Examples 1 to 4 are shown in Table 3 and FIG. 4.

Subsequently, while each of the communication devices 1 according to Conventional Examples 1 to 4 was adhered to a mobile phone, a resonant frequency and the maximum communication distance were measured. The results of the experiments are shown in FIG. 4.

In a case where each of the communication devices according to Conventional Examples 1 to 4 was adhered to a mobile phone was compared with a case where each of the communication devices according to Conventional Examples 1 to 4 was used alone without being adhered to a mobile phone, the resonant frequency and the maximum communication distance were significantly changed and the variations thereof were increased as shown in Table 3 and FIG. 4. In particular, when each of the communication devices according to Conventional Examples 1 to 4 was adhered to a mobile phone, the variation of a resonant frequency was greatly increased as shown in FIG. 4.

When a value of the real part μ′ of the complex relative permeability of the magnetic sheet 3 was changed in the structure in the related art, the variations of a resonant frequency and the maximum communication distance were increased as described above. Accordingly, when a magnetic sheet 3 having different μ′ is used, it was necessary to adjust the thickness or the like of the resin sheet 5, which functioned as a spacer, on all such occasions in accordance with the type of the magnetic sheet 3, which was used, in order to reduce the changes (variations) of a resonant frequency and the maximum communication distance.

Further, as shown in the experimental results of FIG. 4, it was found that a resonant frequency and the maximum communication distance were significantly changed between when the communication device was adhered to a mobile phone and when the communication device was not adhered to a mobile phone even though the real parts μ′ of the complex relative permeability of the magnetic sheets 3 used in the communication devices were equal to each other.

Inventions relating to an RFID communication device are disclosed in International Publication No. 2007/037494, Japanese Unexamined Patent Application Publication No. 2007-233824, and Japanese Unexamined Patent Application Publication No. 2006-127424. However, in International Publication No. 2007/037494, Japanese Unexamined Patent Application Publication No. 2007-233824, and Japanese Unexamined Patent Application Publication No. 2006-127424, the above-mentioned problems in the related art are not recognized and naturally, means for solving the problems are not disclosed.

Meanwhile, an RFID communication device that can make permeability have inclination through the multi-layering of a shield layer (magnetic layer) is disclosed in International Publication No. 2007/037494 (line 16 to 17, page 15), but it is not embodied which structure makes permeability have inclination.

The invention provides a communication device that can suppress the variations of a resonant frequency and the maximum communication distance as compared to the related art.

According to an aspect of the invention, there is provided a communication device. The communication device includes a tag that communicates with an external device by radio, and a magnetic member that is provided on the side opposite to the external device so as to face the tag. The magnetic member is formed to have a laminated structure including a high-μ′ layer that is provided on the tag and a low-μ′ layer which is provided so as to be more distant from the tag than the high-μ′ layer and of which a real part μ′ of complex relative permeability is lower than a real part μ′ of the complex relative permeability of the high-μ′ layer and the thickness is larger than the thickness of the high-μ′ layer.

In the aspect of the invention, the high-μ′ layer, of which the real part μ′ of the complex relative permeability is high and the thickness is small, is disposed on the tag; and the low-μ′ layer of which the real part μ′ of the complex relative permeability is low and the thickness is large, is disposed so as to be distant from the tag. With such a structure, it may be possible to effectively suppress the changes (variations) of a resonant frequency and the maximum communication distance as compared to the related art when the real part μ′ of the complex relative permeability of the high-μ′ layer is appropriately changed. Moreover, in the aspect of the invention, it may be possible to also effectively suppress the variations of a resonant frequency and the maximum communication distance with respect to the presence or absence of metal in the vicinity of the communication device as compared to the related art.

In the aspect of the invention, it is preferable that the real part μ′ of the complex relative permeability of the high-μ′ layer be in the range of 15 to 100. Even though μ′ is changed in this range, it may be possible to effectively suppress the variations of a resonant frequency and the maximum communication distance as compared to the related art. Further, it is preferable that the real part μ′ of the complex relative permeability of the low-μ′ layer be in the range of 1 to 15. Furthermore, in the aspect of the invention, it is preferable that a thickness ratio (t2/t1) be in the range of 5 to 30 when the thickness of the high-μ′ layer is denoted by t1 and the thickness of the low-μ′ layer is denoted by t2. Accordingly, it may be possible to more effectively suppress the variations of a resonant frequency and the maximum communication distance with respect to the change of the value of the real part μ′ of the complex relative permeability of the high-μ′ layer or the variation of μ′ in manufacturing, or with respect to the presence or absence of metal in the vicinity of the communication device, as compared to the related art.

Moreover, in the aspect of the invention, it is preferable that the thickness t1 of the high-μ′ layer be in the range of 30 to 200 μm.

According to the structure of the communication device of the aspect of the invention, it may be possible to effectively suppress the changes (variations) of a resonant frequency and the maximum communication distance as compared to the related art when the real part μ′ of the complex relative permeability of the high-μ′ layer is appropriately changed. Moreover, in the aspect of the invention, it may be possible to also effectively suppress the variations of a resonant frequency and the maximum communication distance with respect to the presence or absence of metal in the vicinity of the communication device as compared to the related art.

### BRIEF DESCRIPTION OF THE DRAWINGS

FIG. 1 is a longitudinal sectional view of a communication device according to the embodiment;

FIG. 2 is a graph showing a relationship between a resonant frequency and the maximum communication distance in Examples 1 to 4;

FIG. 3 is a longitudinal sectional view of a communication device according to a conventional example; and

FIG. 4 is a graph showing a relationship between a resonant frequency and the maximum communication distance in Conventional Examples 1 to 4.

### DESCRIPTION OF THE PREFERRED EMBODIMENTS

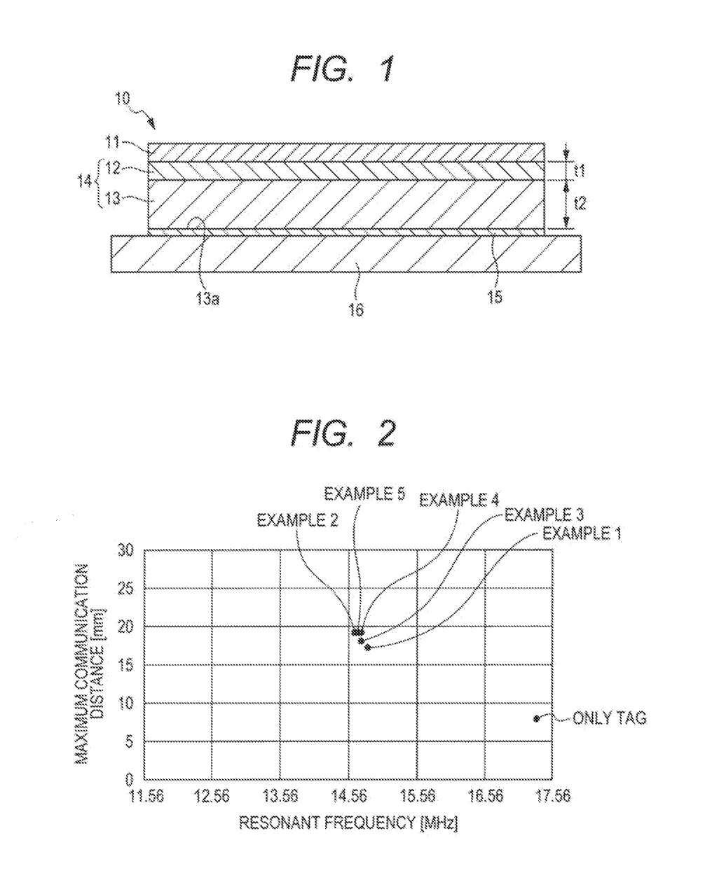

FIG. 1 is a longitudinal sectional view of a communication device 10 according to the embodiment.

A communication device 10 according to this embodiment is used for RFID (Radio Frequency ID). The communication device 10 includes a tag 11 that includes an antenna and an IC chip and a magnetic member 14 that is provided on the side opposite to a reader/writer (not shown) so as to face the tag 11.

The magnetic member 14 is formed to have a laminated structure that includes a high-μ′ layer 12 of which a real part μ′ of the complex relative permeability is high and a low-μ′ layer 13 of which a real part μ′ of the complex relative permeability is lower than the real part μ′ of the complex relative permeability of the high-μ′ layer 12.

The high-μ′ layer 12 and the low-μ′ layer 13 are formed in the shape of a sheet, and are formed so that the thickness t2 of the low-μ′ layer 13 is larger than the thickness t1 of the high-μ′ layer 12.

Further, the high-μ′ layer 12 is provided closer to the tag 11 than the low-μ′ layer 13 as shown in FIG. 1.

A bonding layer 15 is provided on the surface 13a of the low-μ′ layer 13 opposite to the high-μ′ layer 12 as shown in FIG. 1, so that the communication device 10 is adhered to the surface of an electronic device 16 such as a mobile phone through the bonding layer 15. Metal is provided on the surface of the electronic device 16 or inside the electronic device 16. Accordingly, when the communication device 10 is adhered to the surface of the electronic device 16 as shown in FIG. 1, metal is close to the communication device 10.

Meanwhile, when the communication device 10 is not yet adhered to the electronic device 16, a removable protective sheet (protective member) is provided on the surface of the bonding layer 15. After the protective sheet is removed, the communication device 10 is adhered to the electronic device 16. According to this embodiment, the communication device 10 is easily adhered to the electronic device 16 as described above and can communicate with a reader/writer by radio. Further, the communication device 10 may be used alone without removal of the protective sheet.

Here, an acrylic adhesive, a polyester film adhesive tape having an acrylic adhesive, or the like may be used as an adhesive layer in the bonding layer 15.

Meanwhile, although not shown in FIG. 1, a bonding layer, such as a double-sided tape or an adhesive layer, is interposed between the tag 11 and the high-μ′ layer 12 and also between the high-μ′ layer 12 and the low-μ′ layer 13.

The material of each of the high-μ′ layer 12 and the low-μ′ layer 13 is not limited in this embodiment. However, for example, the high-μ′ layer 12 has a structure where powders or scales of a soft magnetic material, such as an Fe—Al—Si alloy or an Fe—M—Cr—P—C (M is one or more of Sn, In, Zn, Ga, Al, Ni, B, and Si) alloy, are bonded with a binder resin. Further, the low-μ′ layer 13 has a structure where powders or scales of a soft magnetic material, such as ferrite or Permalloy, are bonded with a binder resin.

In this embodiment, the real part μ′ of the complex relative permeability of the high-μ′ layer 12 is preferably in the range of 15 to 100 and more preferably in the range of about 20 to 80.

Further, the real part μ′ of the complex relative permeability of the low-μ′ layer 13 is preferably in the range of 1 to 15 and more preferably in the range of about 1 to 10.

Furthermore, a difference between the real part μ′ of the complex relative permeability of the high-μ′ layer 12 and the real part μ′ of the complex relative permeability of the low-μ′ layer 13 is preferably in the range of about 20 to 80.

Moreover, a ratio (t2/t1) of the thickness of the low-μ′ layer 13 to the thickness of the high-μ′ layer 12 is preferably in the range of 5 to 30 and more preferably in the range of about 9 to 21. In this case, the thickness t1 of the high-μ′ layer 12 is preferably in the range of 30 to 200 μm and more preferably in the range of about 50 to 110 μm.

In this embodiment, the magnetic member 14 has been formed to have a laminated structure. However, the high-μ′ layer 12 is disposed on the tag 11, a part of the low-μ′ layer 13 is not formed of a nonmagnetic layer as in the related art, and a large area of the electronic device 16 is formed of the low-μ′ layer 13 slightly having a magnetic property when seen from the entire magnetic member 14, so that it may be possible to reduce the changes (variations) of a resonant frequency and the maximum communication distance even though the real part μ′ of the complex relative permeability of the high-μ′ layer 12 is appropriately changed, specifically, even though μ′ is changed into the range of 15 to 100 (preferably the range of 20 to 80). In addition, with respect to the case where the communication device 10 is used alone and the case where the communication device 10 is used while being adhered to the electronic device 16 as shown in FIG. 1, that is, with respect to the presence or absence of metal in the vicinity of the communication device 10, it may be possible to further suppress the variations of a resonant frequency and the maximum communication distance as compared to the related art.

Further, in this embodiment, it may be possible to further suppress the variations of a resonant frequency and the maximum communication distance as compared to the related art even though there are the variations of the real parts μ′ of the complex relative permeability of the high-μ′ layer 12 and the low-μ′ layer 13 in manufacturing.

Meanwhile, in this embodiment, the high-μ′ layer 12 has been disposed on the tag 11. However, if the high-μ′ layer 12 and the low-μ′ layer 13 are laminated in reverse order, the communication distance is decreased since the high-μ′ layer 12, which is to originally attract magnetic flux generated from a reader/writer toward the tag 11, is distant from the tag 11. For this reason, it is considered that it is not possible to effectively reduce the variations of a resonant frequency and the maximum communication distance with respect to the change of the real part μ′ of the complex relative permeability of the high-μ′ layer 12 or the presence or absence of metal in the vicinity of the communication device.

Further, in this embodiment, the real part μ′ of the complex relative permeability of the low-μ′ layer 13 has been specified in the range of 1 to 15 (preferably in the range of 1 to 10) and a ratio (t2/t1) of the thickness of the low-μ′ layer 13 to the thickness of the high-μ′ layer 12 has been specified in the range of 5 to 30 (preferably in the range of 9 to 21). Accordingly, as described above, as compared to the related art, it may be possible to more effectively suppress the variations of a resonant frequency and the maximum communication distance with respect to the change of the real part μ′ of the complex relative permeability of the high-μ′ layer 12 or the variation of μ′ in manufacturing, or with respect to the presence or absence of metal in the vicinity of the communication device 10.

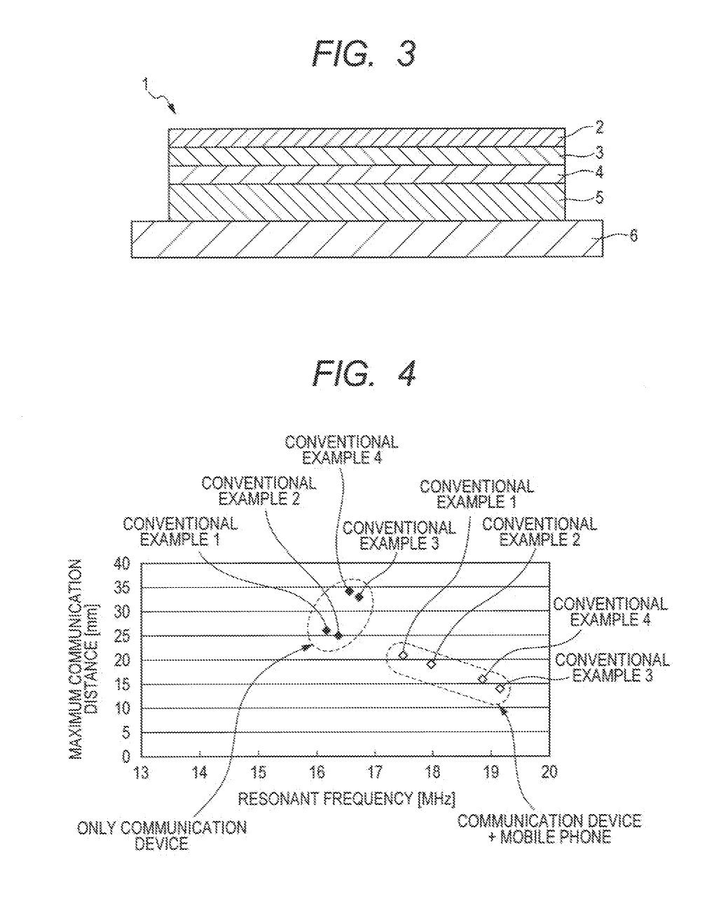

Furthermore, since a base material 4 of the structure in the related art shown in FIG. 3 is not provided in this embodiment, it may be possible to reduce the number of bonding layers that are provided between the respective members. For this reason, it may be possible to suppress the variation of the thickness of the entire communication device 10, which is caused by the variations of the thicknesses of the bonding layers.

### Examples

Communication devices 10 according to Examples 1 to 5 were prepared using magnetic sheets, which have the characteristics shown in the following Table 1, as high-μ′ layers 12. Meanwhile, a ferrite sheet shown in Table 1 was used as a low-μ′ layer 13 of each of Examples 1 to 5.

TABLE 1

| | | μ′ | μ″ | Q | μ′ × t |
|---|---|---|---|---|---|
| High-μ′ layer | Example 1 | 22.33 | 1.06 | 21.2 | 2.01 |
| | 20R-0.09 mm | | | | |
| | Example 2 | 40.77 | 4.96 | 8.2 | 4.32 |
| | 40R-0.106 mm | | | | |
| | Example 3 | 67.70 | 17.95 | 3.8 | 3.32 |
| | 60R-0.049 mm | | | | |
| | Example 4 | 82.38 | 24.56 | 3.4 | 4.04 |
| | 80R-0.049 mm | | | | |
| | Example 5 3M | 26.23 | 1.85 | 14.1 | 2.68 |
| | sheet 0.102 mm | | | | |
| Low-μ′ layer | Ferrite sheet | 11.73 | 0.93 | 12.6 | 11.97 |
| | 1.02 mm | | | | |

A magnetic sheet manufactured by Alps Electric Co., Ltd. was used as each of the high-μ′ layers 12 of Examples 1 to 4. Further, a magnetic sheet manufactured by 3M was used as the high-μ′ layer 12 of Example 5. Numerical values in millimeters represent the thicknesses of the sheets. Further, Table 1 shows the real part μ′ of the complex relative permeability of each of the magnetic sheets, and the like.

In the communication device 10 that is shown in FIG. 1 and includes the above-mentioned magnetic sheet, a double-sided tape having a thickness of about 10 μm was interposed between the tag 11 and the high-μ′ layer 12 and an adhesive layer having a thickness of about 50 μm was interposed between the high-μ′ layer 12 and the low-μ′ layer 13. Further, a double-sided tape having a thickness of 125 μm was used as the bonding layer 15 shown in FIG. 1.

In experiments, a resonant frequency and the maximum communication distance of a single tag 11 were obtained first. DENSO WAVE PR-301RKM was used as a reader/writer. The results of the experiments are shown in FIG. 2. In an RFID system, a prescribed frequency fc is 13.56 MHz. However, the resonant frequency of the single tag 11 used in this experiment is set to a value larger than 13.56 MHz.

Next, while a communication device 10 according to each of Examples 1 to 5 shown in Table 1 was adhered to a mobile phone as shown in FIG. 1, a resonant frequency and the maximum communication distance were obtained. The results of the experiments are shown in the following Table 2 and FIG. 2.

TABLE 2

| | |
|---|---|
| | Single |
| | communication |
| Adhered to mobile phone | device (not |
| (including metal) | including metal) |

| | Maximum | Resonant | Resonant |
|---|---|---|---|
| | communication | frequency | frequency |
| | distance | [MHz] | [MHz] |
| Example 1 | 17 | 14.89 | 14.38 |
| Example 2 | 19 | 14.71 | 14.2 |
| Example 3 | 18 | 14.8 | 14.26 |
| Example 4 | 19 | 14.77 | 14.2 |
| Example 5 | 19 | 14.74 | 14.26 |

The real parts μ′ of the complex relative permeability of the high-μ′ layers 12 of the respective Examples 1 to 5 were changed in the range of about 20 to 80. However, even though the real parts μ′ of the complex relative permeability of the high-μ′ layers 12 were changed as described above, it was possible to reduce the variations of a resonant frequency and the maximum communication distance of each Example as shown in FIG. 2.

Subsequently, the resonant frequencies of the single communication devices 10 according to the respective Examples 1 to 5 were measured. The results of the experiments are shown in Table 2.

As shown in Table 2, it was found that a shift in resonant frequency was greatly reduced when the communication device 10 was adhered to a mobile phone (when metal was close to the communication device 10) and when the communication device 10 was used alone.

It should be understood by those skilled in the art that various modifications, combinations, sub-combinations and alterations may occur depending on design requirements and other factors insofar as they are within the scope of the appended claims of the equivalents thereof.

What is claimed is:

1. A communication device comprising:
a tag that communicates with an external device by radio; and
a magnetic member that is provided on the side opposite to the external device so as to face the tag,
wherein the magnetic member is formed to have a laminated structure including a high-μ′ layer that is provided on the tag and a low-μ′ layer which is provided so as to be more distant from the tag than the high-μ′ layer and of which a real part μ′ of complex relative permeability is lower than a real part μ′ of the complex relative permeability of the high-μ′ layer and the thickness is larger than the thickness of the high-μ′ layer.

2. The communication device according to claim 1,
wherein the real part μ′ of the complex relative permeability of the high-μ′ layer is in the range of 15 to 100.

3. The communication device according to claim 1,
wherein the real part μ′ of the complex relative permeability of the low-μ′ layer is in the range of 1 to 15.

4. The communication device according to claim 1,
wherein a thickness ratio (t2/t1) is in the range of 5 to 30 when the thickness of the high-μ′ layer is denoted by t1 and the thickness of the low-μ′ layer is denoted by t2.

5. The communication device according to claim 4,
wherein the thickness t1 of the high-μ′ layer is in the range of 30 to 200 μm.
